(19) United States
(12) Patent Application Publication
(10) Pub. No.: US 2026/0084215 A1
(43) Pub. Date: Mar. 26, 2026

(54) METHOD AND PLANNING DEVICE FOR PLANNING LOCAL SELECTIVE IRRADIATION OF A WORK REGION USING AN ENERGY BEAM, AND METHOD AND MANUFACTURING DEVICE FOR ADDITIVELY MANUFACTURING A COMPONENT FROM A POWDER MATERIAL

(71) Applicant: Additive Manufacturing IP GmbH, Munich (DE)

(72) Inventors: Bernhard GUTMANN, Pfaffenhofen a.d. Glonn (DE); Sarah BRANDT, Renningen (DE)

(21) Appl. No.: 19/403,071

(22) Filed: Nov. 27, 2025

Related U.S. Application Data
(63) Continuation of application No. PCT/EP2024/063163, filed on May 14, 2024.

(30) Foreign Application Priority Data
May 30, 2023 (DE) 10 2023 114 133.3

(51) Int. Cl. B22F 10/28; B22F 10/366; B33Y 10/00; B33Y 30/00; B33Y 50/02

(52) U.S. Cl. CPC B22F 10/28; B22F 10/366; B33Y 10/00; B33Y 30/00; B33Y 50/02

(57) ABSTRACT

A method for planning a locally selective irradiation of a working region with an energy beam, to produce one component layer by layer from a plurality of powder material layers of a powder material arranged in a layer sequence in temporal succession in the working region via the energy beam includes planning irradiation of a plurality of irradiation regions on the working region with the at least one energy beam. A respective assigned parameter value of at least one irradiation parameter is selected for the irradiation regions of the plurality of irradiation regions. The assigned parameter value is selected depending on an assignment of the respective irradiation region to a subregion of at least two subregions of the working region. An irradiation plan for the locally selective irradiation of the working region with the at least one energy beam is obtained in at least one powder material layer.

### CROSS REFERENCE TO RELATED APPLICATIONS

This application is a continuation of International Application No. PCT/EP2024/063163 (WO 2024/245732 A1), filed on May 14, 2024, and claims benefit to German Patent Application No. DE 10 2023 114 133.3, filed on May 30, 2023. The aforementioned applications are hereby incorporated by reference herein.

### FIELD

The invention relates to a method and a planning device for planning a locally selective irradiation of a working region with an energy beam, as well as a method and a manufacturing device for additive manufacturing of a component from a powder material.

### BACKGROUND

When manufacturing components by means of locally selective irradiation of a working region with an energy beam, various disturbance variables can cause different component properties to result depending on the location of the irradiation on the working region, even if the irradiation parameters are otherwise identical. Examples of such disturbance variables are locally different conditions resulting from symmetry-breaking gas flow or inhomogeneities in the gas flow over the working region, or resulting from locally different angles of incidence of the energy beam. This in turn can result in inhomogeneities within a component or in different properties of different, manufactured simultaneously at different locations on the working region. Both are undesirable, as they lead to a lack of reproducibility of the process and/or reduced component quality.

### SUMMARY

In an embodiment, the present disclosure provides a method for planning a locally selective irradiation of a working region with at least one energy beam, to produce one component layer by layer from a plurality of powder material layers of a powder material arranged in a layer sequence in temporal succession in the working region via the at least one energy beam includes planning irradiation of a plurality of irradiation regions on the working region with the at least one energy beam. A respective assigned parameter value of at least one irradiation parameter is selected for the irradiation regions of the plurality of irradiation regions. The assigned parameter value is selected depending on an assignment of the respective irradiation region to a subregion of at least two subregions of the working region. An irradiation plan for the locally selective irradiation of the working region with the at least one energy beam is obtained in at least one powder material layer.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an embodiment of a manufacturing device for additive manufacturing of components from a powder material with an embodiment of a planning device;

FIG. 2 shows a schematic representation of a first embodiment of a method for planning a locally selective irradiation of a working region with an energy beam;

FIG. 3a and FIG. 3b show a schematic detailed representations of further embodiments of the method for a planning locally selective irradiation of a working region with an energy beam.

### DETAILED DESCRIPTION

An embodiment of the present disclosure provides a method and a planning device for planning a locally selective irradiation of a working region with an energy beam, as well as a method and a manufacturing device for additive manufacturing of a component from a powder material, wherein the aforementioned disadvantages are at least reduced, or preferably do not occur.

An embodiment of the present disclosure provides a method—hereinafter also referred to as a planning method—for planning a locally selective irradiation of a working area with at least one energy beam in order to produce at least one component layer by layer from a plurality of powder material layers of a powder material arranged in a layer sequence in temporal succession in the working area by means of the at least one energy beam, wherein irradiation of a plurality of irradiation regions on the working region with the at least one energy beam is planned, wherein for the irradiation regions, in particular for each irradiation region, of the plurality of irradiation regions, a respective assigned parameter value of at least one irradiation parameter is selected, wherein the assigned parameter value is selected depending on an assignment of the respective irradiation region to a subregion of at least two subregions of the working region. By assigning the respective irradiation region to a subregion of the working region and selecting the respective assigned parameter value depending on this assignment, it is advantageously possible to take into account location dependencies in the manufacturing conditions on the working region during irradiation and thus, in particular, to compensate for different local conditions or to homogenize manufacturing at different locations of the working region. This has the advantage of at least reducing, and preferably avoiding, local variations in component properties occurring across the working region, thereby increasing the reproducibility of production and the quality of the components.

In particular, an irradiation plan for the locally selective irradiation of the working region with the at least one energy beam in the at least one powder material layer is obtained, in particular as a result or product of the planning method.

In the context of the present disclosure, an irradiation region is understood in particular to be an area that is irradiated completely, in particular systematically, in particular with a defined direction of displacement of the energy beam with an energy beam. Such an irradiation region comprises in particular at least two irradiation vectors, which are irradiated with the energy beam in particular immediately one after the other in time, i.e., are processed by the energy beam. In particular, such an irradiation region can be formed as a strip of irradiation vectors aligned parallel to each other and arranged next to each other perpendicular to their alignment.

An irradiation vector is understood in particular to be a continuous, in particular linear, displacement of the energy beam over a certain distance with a certain direction of displacement. The irradiation vector includes, in particular, the direction and orientation of the displacement, i.e., the vector alignment. The irradiation vector does not have to be formed as a straight line segment; rather, an irradiation vector can also follow a line or curve that is curved at least in some areas.

In the context of the present disclosure, irradiation or processing of an irradiation vector is understood in particular to mean that irradiation of the powder material in the working region is carried out in accordance with the definition given by the irradiation vector.

In particular, the respective parameter value of the at least one irradiation parameter is assigned to the respective associated irradiation area. In particular, at least one irradiation parameter is used for a plurality of different irradiation areas within the framework of the planning method, wherein different parameter values of the irradiation parameter are assigned to the different irradiation areas depending on the assignment to a respective subregion of the working region.

In particular, the assigned parameter value is selected depending on a geometric assignment of the respective irradiation region to the respective subregion, in particular depending on a geometric position of the irradiation region relative to the subregion.

In an embodiment, different parameter values of the at least one irradiation parameter are assigned to the subregions. In another embodiment, the same parameter value is assigned to a first group of subregions, wherein at least one further subregion or at least a second group of subregions is assigned a different parameter value. In particular, the parameter value assigned to the subregion to which the irradiation region is assigned is assigned to an irradiation region.

In particular, for a plurality of powder material layers, in particular for all powder material layers, irradiation of a plurality of irradiation regions on the working region with the at least one energy beam is planned, wherein a respective assigned parameter value of at least one irradiation parameter is selected for the irradiation areas of the plurality of irradiation areas of the respective powder material layer, wherein the assigned parameter value is selected depending on the assignment of the respective irradiation area to a subregion of at least two subregion of the working region. In particular, this procedure is carried out for all powder material layers of the plurality of powder material layers. In particular, an irradiation plan is thus obtained for all powder material layers. In particular, the method is carried out iteratively—powder material layer by powder material layer.

Additive or generative manufacturing or production of a component is understood in particular to mean the layer-by-layer construction of a component from powder material, in particular a powder bed-based method for producing a component in a powder bed, in particular a manufacturing method selected from a group consisting of selective laser sintering, laser metal fusion (LMF), direct metal laser melting (DMLM), laser net shaping manufacturing (LNSM), (selective) electron beam melting ((S)EBM), and laser engineered net shaping (LENS). The manufacturing device is therefore specifically designed to perform at least one of the aforementioned additive or generative manufacturing methods.

The energy beam is specifically selected from a group consisting of an electromagnetic beam, specifically an optical working beam, specifically a laser beam, and a particle beam, specifically an electron beam. The energy beam can be continuous or pulsed, in particular continuous laser radiation or pulsed laser radiation. In an embodiment with a plurality of energy beams, in a specific configuration all energy beams are laser beams.

In particular, within the framework of the planning method, locally selective irradiation of a working region with a plurality of energy beams can be planned in order to use the plurality of energy beams to produce one or more components layer by layer from a plurality of powder material layers of a powder material arranged in a layer sequence in temporal succession in the working region. In an embodiment, it is possible for all energy beams to be displaced over the entire working region. However, it is also possible for certain energy beams of the plurality of energy beams to be assigned specific partial displacement regions on the working region within which they can be displaced, wherein these energy beams cannot be displaced in other partial displacement regions in particular. In particular, in the case of larger manufacturing devices or larger working regions, it is possible that certain energy beams cannot reach certain partial displacement regions of the working region due to their design.

If a plurality of energy beams is used, it is possible that, at least for a minority of the energy beams that is smaller than the total number of energy beams, but in particular for all energy beams, separate subregions are defined on the working region, wherein the selection of the respective parameter values is made depending on the assignment of an irradiation region assigned to a specific energy beam to a subregion of the working region assigned to the same energy beam. Alternatively, however, when using a plurality of energy beams, it is also possible for the subregions on the working region to be defined uniformly at least for a subset of energy beams, but in particular for all energy beams, so that the assignment of a subregion to a specific energy beam is irrelevant in this respect.

According to an embodiment of the present disclosure, it is provided that the at least one irradiation parameter is selected from a group consisting of: an irradiation order of at least two irradiation vectors within the respective irradiation region, a position of the irradiation region in a processing order of the plurality of irradiation regions, a vector direction of the irradiation vectors, a vector orientation of the irradiation vectors, a sequence of vector orientations of the irradiation vectors, in particular within the irradiation region, a distance between mutually adjacent irradiation vectors of the irradiation region, a beam power of the at least one energy beam, a shape of the energy beam on the working region, a size of the energy beam on the working region, a displacement velocity of the at least one energy beam on the working region, a flow velocity of a protective gas flow over the working region, a flow direction of the protective gas flow, a position of the irradiation region on the working region, and a combination of at least two of the aforementioned irradiation parameters. These irradiation parameters are particularly suitable for compensating for local differences in the irradiation conditions on the working region by varying the parameter values.

In the context of the present disclosure, an irradiation order of at least two irradiation vectors within the respective irradiation region is understood in particular to mean a vector processing order of the irradiation vectors, i.e., an order in which the irradiation vectors are processed one after the other in time. In particular, the irradiation order is a vector processing order along a processing direction determined for the irradiation region. A processing direction is understood to be, in particular, the direction along which the irradiation vectors, which are arranged in particular parallel to each other, are processed sequentially in time.

In the context of the present disclosure, a position of the irradiation region in a processing order of the plurality of irradiation regions is understood in particular to mean the position or rank within the processing order of the irradiation region under consideration. The processing order of the plurality of irradiation regions is understood to be a temporal order in which the various irradiation regions are processed one after the other.

In the context of the present disclosure, the vector direction of an irradiation vector is understood in particular to be a direction of the irradiation vector on the working region. The direction can be specified, for example, in the form of an angle that the irradiation vector forms with a reference axis or preferred direction defined on the working region.

In contrast, in the context of the present disclosure, the vector orientation of an irradiation vector is understood in particular as how the irradiation vector is oriented on the working region, i.e., how a starting point and an end point of the displacement of the energy beam are arranged along the irradiation vector, or, in other words, in which direction the vector arrow of the irradiation vector points. In particular, two different vector orientations result for a given vector direction of an irradiation vector. The vector orientation of the irradiation vector is thus completely specified by the specification of the vector direction on the one hand and the vector orientation on the other.

In the context of the present disclosure, a sequence of vector orientations of the irradiation vectors is accordingly understood in particular as how the vector orientations of the irradiation vectors of an irradiation region arranged parallel to each other along the processing direction are aligned with each other. In particular, the adjacent irradiation vectors can be aligned in the same direction or alternately. If the irradiation vectors are alternately aligned, they can be aligned individually, i.e., exactly alternately, or within vector groups concordantly and alternately in groups.

The distance between immediately adjacent irradiation vectors is understood to be, in particular, a minimum geometric distance between two immediately adjacent irradiation vectors of an irradiation region, which is measured, in particular, perpendicular to the vector direction of at least one of the irradiation vectors, in particular perpendicular to the vector direction of both irradiation vectors oriented parallel to each other. The distance may be identical within the irradiation region for all pairs of immediately adjacent irradiation vectors, or it may vary within the irradiation region.

In the context of the present disclosure, the shape of the energy beam on the working region is understood in particular to mean the shape of a projection of the energy beam onto the working region, i.e., in particular, a cross-sectional shape of the energy beam that results on the working region. A boundary line or outline of the shape is defined in particular at a predetermined percentage of the peak power of the energy beam. In particular, the shape of the energy beam on the working region—especially in the case of non-rotationally symmetrical shapes—includes a direction and preferably also an orientation of the shape.

In the context of the present disclosure, the size of the energy beam on the working region is understood in particular to be a measure of the extent of the shape of the energy beam, for example a diameter or the like.

In the context of the present disclosure, the position of the irradiation region on the working region is understood in particular to mean a geometric position of the irradiation region, possibly also a plurality of irradiation regions or even all irradiation regions of a specific component or an island of a component, on the working region. In particular, the position of the irradiation region—especially in the case of non-rotationally symmetrical irradiation regions—includes a direction and preferably also an orientation of the irradiation region.

In particular, in an embodiment, the irradiation parameter is the irradiation order of at least two irradiation vectors within the respective irradiation region. Alternatively or additionally, the irradiation parameter is the position of the irradiation area in a processing order of the plurality of irradiation areas. Alternatively or additionally, the vector direction and/or vector orientation of the irradiation vectors is used as the irradiation parameter. Alternatively or additionally, the sequence of vector orientations of the irradiation vectors is used as the irradiation parameter. Alternatively or additionally, the position of the irradiation region on the working region, in particular its direction and/or orientation, is used as the irradiation parameter.

In particular, in an embodiment, only the irradiation order of at least two irradiation vectors within the respective irradiation region is used as the sole irradiation parameter, the parameter value of which is selected depending on the assigned subregion. In particular, in this embodiment, all other irradiation parameters that may still be used are defined independently of the assignment of a specific subregion.

In particular, in another embodiment, the irradiation order of at least two irradiation vectors within the respective irradiation region and the vector direction of the irradiation vectors are used as the at least one irradiation parameter—in particular, exclusively. In an embodiment, the sequence of vector orientations of the irradiation vectors is additionally used as the irradiation parameter. Alternatively or additionally, the position of the irradiation region on the working region, in particular its direction and/or orientation, is used as the irradiation parameter.

In particular, in yet another embodiment, the irradiation order of at least two irradiation vectors within the respective irradiation region and the vector orientation of the irradiation vectors are used as the at least one irradiation parameter—in particular exclusively. In an embodiment, the sequence of vector orientations of the irradiation vectors is additionally used as the irradiation parameter. Alternatively or additionally, the position of the irradiation region on the working region, in particular its direction and/or orientation, is used as the irradiation parameter.

In another embodiment, the irradiation order of at least two irradiation vectors within the respective irradiation region, the vector direction and the vector orientation of the irradiation vectors are used as the at least one irradiation parameter—in particular exclusively. In an embodiment, the sequence of vector orientations of the irradiation vectors is additionally used as the irradiation parameter. Alternatively or additionally, the position of the irradiation region on the working region, in particular its direction and/or orientation, is used as the irradiation parameter.

In another embodiment, the irradiation order of at least two irradiation vectors within the respective irradiation region, the position of the irradiation region in a processing order of the plurality of irradiation areas, and the vector direction of the irradiation vectors are used as the at least one irradiation parameter—in particular exclusively. In an embodiment, the sequence of vector orientations of the irradiation vectors is additionally used as the irradiation parameter. Alternatively or additionally, the position of the irradiation region on the working region, in particular its direction and/or orientation, is used as the irradiation parameter.

In particular, in yet another embodiment, the irradiation order of at least two irradiation vectors within the respective irradiation region, the position of the irradiation region in a processing order of the plurality of irradiation areas, and the vector orientation of the irradiation vectors are used as the at least one irradiation parameter—in particular exclusively. In an embodiment, the sequence of vector orientations of the irradiation vectors is additionally used as the irradiation parameter. Alternatively or additionally, the position of the irradiation region on the working region, in particular its direction and/or orientation, is used as the irradiation parameter.

In another embodiment, the irradiation order of at least two irradiation vectors within the respective irradiation region, the position of the irradiation region in a processing order of the plurality of irradiation regions, the vector direction of the irradiation vectors, and the vector orientation of the irradiation vectors are used as the at least one irradiation parameter—in particular exclusively. In an embodiment, the sequence of vector orientations of the irradiation vectors is additionally used as the irradiation parameter. Alternatively or additionally, the position of the irradiation region on the working region, in particular its direction and/or orientation, is used as the irradiation parameter.

In another embodiment, the irradiation order of at least two irradiation vectors within the respective irradiation region, the position of the irradiation region in a processing order of the plurality of irradiation areas, the vector direction of the irradiation vectors, the vector orientation of the irradiation vectors, and the sequence of vector orientations of the irradiation vectors are used as the at least one irradiation parameter—in particular exclusively. In an embodiment, the position of the irradiation region on the working region, in particular its direction and/or orientation, is additionally used as the irradiation parameter.

In another embodiment, the irradiation order of at least two irradiation vectors within the respective irradiation region, the position of the irradiation region in a processing order of the plurality of irradiation areas, the vector direction of the irradiation vectors, the vector orientation of the irradiation vectors, the sequence of vector orientations of the irradiation vectors, and the position of the irradiation region on the working region, in particular its direction and/or orientation are used as the at least one irradiation parameter—in particular exclusively.

According to a further development of the invention, it is provided that the at least two subregions used as fields on the working region are selected from a group consisting of: sectors, sector segments, circle segments, annuli, rectangular fields, free-form fields, and a combination of at least two of the aforementioned fields. The fields mentioned here are particularly suitable for use as subregions in the planning method in order to advantageously take into account different local irradiation conditions on the working region.

In the context of the present disclosure, a sector is understood in particular to mean a circular sector. A circular segment is understood in particular to mean a circle segment. A sector segment is understood to mean either an intersection of a circular sector and a circle segment, or an intersection of a circular sector and an annulus.

In particular, in an embodiment, sectors are used as the at least two subregions. Alternatively or additionally, sector segments are used as the at least two subregions. Alternatively or additionally, circle segments are used as the at least two subregions. Alternatively or additionally, annuli are used as the at least two subregions.

In an embodiment, sectors and sector segments, in particular in the form of intersections of these fields, are used as the at least two subregions.

In another embodiment, sectors and annuli, in particular in the form of intersections of these fields, are used as the at least two subregions.

In particular, the at least two subregions can be designed as square fields, in particular arranged in the form of chessboards. In another embodiment, an arrangement of the subregions in the form of pie slices can be considered, in particular if sectors are used as the subregions. An arrangement of the subregions as fields resulting from a—in particular multiple—division of a circular working region by at least one straight line, in particular by straight lines parallel offset to each other, is also possible; in particular, straight lines that are partially oriented parallel to each other and partially perpendicular to each other can also be used here.

In particular, in an embodiment, the irradiation order of at least two irradiation vectors within the respective irradiation region is used as the irradiation parameter, and the at least two subregions are sectors or rectangular fields.

In another embodiment, the irradiation sequence of at least two irradiation vectors within the respective irradiation region is used as the irradiation parameter, and the at least two subregions are circle segments.

In another embodiment, the irradiation order of at least two irradiation vectors within the respective irradiation region is used as the irradiation parameter, and the at least two subregions are sectors and circle segments, in particular in the form of intersections of these fields.

In another embodiment, the irradiation order of at least two irradiation vectors within the respective irradiation region is used as the irradiation parameter, and the at least two subregions are sectors and annuli, in particular in the form of intersections of these fields.

According to an embodiment of the present disclosure, it is provided that at least one—in particular imaginary—separation line, which separates the at least two subregions on the working region from each other, is or will be defined on the working region in such a way that it runs adjacent to at least one energy beam center. Advantageously, the at least one separation line can be or is defined with reference to at least one energy beam center, wherein particular advantages arise in connection with the irradiation order of at least two irradiation vectors within an irradiation region relative to such an energy beam center. In particular, it has been found that better component properties result when the irradiation order of the irradiation vectors is directed away from the associated energy beam center, i.e., irradiation vectors that are closer to the energy beam center are processed before irradiation vectors that are further away from the energy beam center. Such a relationship was also found for the vector alignment of the irradiation vectors, wherein better component properties result for irradiation vectors that are aligned in the direction of the associated energy beam center than for irradiation vectors that are aligned away from the energy beam center.

The fact that an energy beam center is assigned to an irradiation vector or irradiation area means, in particular, that the energy beam center is assigned to the energy beam with which the irradiation vector or irradiation area is irradiated.

In the context of the present disclosure, an energy beam center is understood in particular to be a location on the working region that results as the base point of a scanner device for displacing an energy beam, in particular by dropping a perpendicular onto the working region from a starting point of the energy beam on the scanner device.

In an embodiment, it is provided that the at least one separation line is defined in the planning method. In this case, the planning method includes defining the at least one separation line as a process step. In another embodiment, the at least one separation line is predetermined from the perspective of the planning method, wherein it can be stored in a suitable form or, in particular, obtained from an external computing device or upstream routine. It is also possible for a user to define the at least one separation line manually, in particular via a user interface.

In particular, the at least one separation line is or will be defined on the working region in such a way that it runs at a predetermined distance from the energy beam center. The predetermined distance is, in particular, a minimum distance between the energy beam center and the separation line, which is measured, in particular, locally perpendicular to the separation line.

Alternatively or in addition to the course of the at least one separation line adjacent to the at least one energy beam center, an embodiment provides that the at least one separation line is or becomes defined on the working region in such a way that it passes through the at least one energy beam center.

Furthermore, alternatively or additionally, in an embodiment, the at least one separation line is or becomes provided on the working region in such a way that it passes through a center of gravity of a plurality of energy beam centers.

In the context of the present disclosure, a center of gravity is generally understood to be, in particular, a geometric center of gravity, i.e., in particular, a point obtained by averaging all relevant points, specifically all energy beam centers at this location. In the case of a symmetrical arrangement of points, the center of gravity is the center of this arrangement.

According to an embodiment of the present disclosure, it is provided that the at least one separation line separating the at least two subregions on the working region is or will be defined on the working region in such a way that it runs transversely, in particular perpendicularly, to a flow direction of a protective gas flow over the working region. This has the advantage of allowing the influence of the protective gas flow on the irradiation conditions to be additionally taken into account.

In particular, in an embodiment, it is provided that the at least one separation line is or will be defined on the working region in such a way that it runs adjacent to at least one energy beam center, or through the at least one energy beam center, or through a center of gravity of a plurality of energy beam centers, and that it additionally runs transversely, in particular perpendicularly, to the flow direction of the protective gas flow over the working region.

In an embodiment, it is further provided that the at least one irradiation parameter is selected from a group consisting of: an irradiation order of at least two irradiation vectors within the respective irradiation region, a position of the irradiation region in a processing order of the plurality of irradiation regions, a vector direction of the irradiation vectors, a vector orientation of the irradiation vectors, and a combination of at least two of the aforementioned irradiation parameters. In particular, in this way, the choice of irradiation parameter can be made depending on the assignment to the respective subregion in such a way that the displacement direction of the energy beam—whether with regard to the order of the irradiation vectors, with regard to the displacement along the individual irradiation vectors, or with regard to the processing of the various irradiation regions one after the other—both with regard to the at least one energy beam center and relative to the flow direction, is aligned in a manner suitable for the highest possible reproducibility and the highest possible component quality.

This is particularly the case when the irradiation order of at least two irradiation vectors within the respective irradiation region is advantageously used as the at least one irradiation parameter: If the at least one separation line is defined in such a way that it runs adjacent to the at least one energy beam center, or through the at least one energy beam center, or through a center of gravity of a plurality of energy beam centers, and that it additionally runs transversely, in particular perpendicularly, to the flow direction of the protective gas flow above the working region, the working region is in any case divided into at least two subregions, of which a first subregion is located closer to the source of the protective gas flow, i.e., upstream of the protective gas flow, starting from the separation line against the protective gas flow, wherein a second subregion is located further away from the source of the protective gas flow, i.e., downstream of the protective gas flow, starting from the separation line. The irradiation order of the irradiation vectors is now selected for at least one first irradiation region assigned to the first subregion in such a way that it is aligned against the protective gas flow, so that irradiation vectors that are closer to the separation line and further away from the source of the protective gas flow are irradiated before irradiation vectors that are further away from the separation line and closer to the source of the protective gas flow. Thus, in the first irradiation region, the irradiation order is simultaneously aligned away from the at least one energy beam center, i.e., irradiation vectors that are closer to the at least one energy beam center are irradiated before irradiation vectors that are further away from the at least one energy beam center. For at least one second irradiation region assigned to the second subregion, the irradiation order is selected so that it is aligned with the protective gas flow, so that irradiation vectors that are closer to the separation line and closer to the source of the protective gas flow are irradiated before irradiation vectors that are further away from the separation line and further away from the source of the protective gas flow. Thus, the irradiation order in the second irradiation region is also aligned away from the at least one energy beam center.

According to an embodiment of the present disclosure, it is provided that the at least two subregions are defined on the working region before the irradiation of the plurality of irradiation regions is planned. In this case, it is advantageous to define the at least two subregions as part of the planning method, as a step preceding the planning of the irradiation. In this case, the planning method provides complete control over the embodiment of the irradiation, including the definition of the subregions. These can be defined automatically by a planning device, in particular the planning device described below, which is according to the present disclosure, or a planning device according to one or more of the embodiments described below, or by a user, in particular via a human-machine interface.

In an embodiment, it is provided that the at least two subregions are defined on the working region by defining the at least one separation line on the working region, which separates the at least two subregions of the at least two subregions from each other. By defining the at least one separation line, the at least two subregions are advantageously defined in a simple manner at the same time. The at least one separation line can be defined automatically by the planning device, in particular the planning device according to the present disclosure described below or a planning device according to one or more of the embodiments described below, or by a user, in particular via a human-machine interface.

According to an embodiment of the present disclosure, it is provided that the at least one separation line is a line selected from a group consisting of: a radius line, a diameter line, a circle centered at a center point or, in particular, a geometric center of gravity of the working region, a secant, a chord, a parallel line to a boundary edge of the working region, and a combination of at least two of the aforementioned lines. Such separation lines are particularly advantageous for defining at least two subregions as fields on the working region, which are selected from the group consisting of: sectors, sector segments, circle segments, annuli, rectangular fields, free-form fields, and a combination of at least two of the aforementioned fields.

According to an embodiment of the present disclosure, it is provided that the respective irradiation region is assigned to a specific subregion of the at least two subregions if a position of a—in particular geometric—center of gravity of the respective irradiation region on the working region falls within the specific subregion. In this way, the respective irradiation region is advantageously assigned to the subregion in which it is located for the most part, in particular with regard to its area.

Alternatively or additionally, in an embodiment, it is provided that the respective irradiation region is assigned to a specific subregion of the at least two subregions if the respective irradiation region is located in the specific subregion. This advantageously represents a particularly simple assignment rule based on the geometric position of the irradiation regions relative to the subregions.

In an embodiment, the respective irradiation region is divided if it falls within more than one subregion of the at least two subregions. In this way, even irradiation regions that fall into more than one subregion, in particular irradiation regions that are divided by at least one separation line, can be easily assigned to the corresponding subregions. The appropriate division of the irradiation regions ensures that, as a result, only those irradiation regions remain that are completely and unambiguously located in one subregion.

Alternatively, it is possible that for irradiation regions that are located entirely within a single subregion, the simple rule is applied that they are assigned to this subregion, wherein other irradiation regions that are located in at least two subregions, in particular because they are divided by at least one separation line, are each assigned to the subregion in which their respective center of gravity falls. However, the result of this approach is identical to applying the assignment according to the center of gravity for each subregion, but may be easier and faster to calculate.

According to an embodiment of the present disclosure, it is provided that a first predetermined parameter value is assigned to the at least one irradiation parameter as the assigned parameter value if the respective irradiation region is assigned to a first subregion of two subregions of the working region, wherein a second parameter value, predetermined parameter value different from the first parameter value is assigned to the at least one irradiation parameter as the assigned parameter value if the respective irradiation region is assigned to a second subregion of the two subregions. This advantageously represents a particularly simple and at the same time functional embodiment of the planning method.

In particular, an embodiment provides that the first predetermined parameter value is assigned to the at least one irradiation parameter as the assigned parameter value if the respective irradiation region is assigned to the first subregion of exactly two subregions of the working region, wherein the second predetermined parameter value, which differs from the first parameter value, is assigned to the at least one irradiation parameter as the assigned parameter value if the respective irradiation region is assigned to the second subregion of the exactly two subregions.

In an embodiment of the planning method, it is additionally provided that exactly one irradiation parameter of a plurality of irradiation parameters is optionally assigned either the first predetermined parameter value or the second predetermined parameter value. In particular, the other irradiation parameters of the plurality of irradiation parameters are selected independently of the assignment of the respective irradiation region to a subregion of the working region, in particular identically for all subregions.

In an embodiment, the irradiation order of at least two irradiation vectors within a respective irradiation region is used alternatively or additionally as the at least one irradiation parameter.

According to an embodiment of the present disclosure, it is provided that the irradiation order of at least two irradiation vectors within the respective irradiation region is used as the at least one irradiation parameter, wherein the irradiation order is selected along a first processing direction if the respective irradiation region is assigned to a first subregion of—in particular exactly—two subregions of the working region, wherein the irradiation order is selected along a second processing direction if the respective irradiation region is assigned to a second subregion of the—in particular exactly—two subregions, wherein the first processing direction has at least one component that is aligned antiparallel to a flow direction of a protective gas flow over the working region, wherein the second processing direction has at least one component that is aligned parallel to the flow direction, wherein, in particular, the second processing direction is aligned antiparallel to that of the first processing direction. Advantageously, the processing direction in the respective subregions is thus defined relative to the flow direction.

In particular, in an embodiment, it is additionally provided that the separation line is or will be defined on the working region in such a way that it runs adjacent to at least one energy beam center, or through the at least one energy beam center, or through a center of gravity of a plurality of energy beam centers. Advantageously, the processing direction in the respective subregions is thus defined relative to the flow direction and additionally relative to the position of the at least one energy beam center.

In particular, in an embodiment, it is further additionally provided that the separation line is or will be defined on the working region in such a way that it runs transversely, in particular perpendicularly, to the flow direction of the protective gas flow above the working region. In particular, the first subregion is arranged upstream of the protective gas flow starting from the separation line, and the second subregion is arranged downstream of the protective gas flow starting from the separation line. Thus, the irradiation order in at least one first irradiation region assigned to the first subregion is simultaneously aligned, at least in terms of components, against the protective gas flow and away from the at least one energy beam center. In at least one second irradiation region assigned to the second subregion, the irradiation order is aligned, at least in terms of components, with the protective gas flow and away from the at least one energy beam center.

According to an embodiment of the present disclosure, it is provided that the irradiation is planned with a plurality of energy beams, wherein an additional irradiation parameter is used in the form of an assignment of a specific energy beam from the plurality of energy beams to the respective irradiation region. This has the advantage that it is possible to assign an energy beam to each irradiation region, the energy beam center of which is located as close as possible to the respective irradiation region, in particular as close as possible to the—in particular geometric—center of gravity of the irradiation region. In this way, flat irradiation angles on the working region for the energy beams are advantageously avoided where possible.

According to an embodiment of the present disclosure, it is provided that the irradiation is planned with a plurality of energy beams, wherein the assigned parameter value of the at least one irradiation parameter is additionally selected depending on an assignment of a specific energy beam of the plurality of energy beams to the respective irradiation region. In particular, this advantageously allows the relative position of the respective energy beam center to the assigned irradiation region, in particular to the—in particular geometric—center of gravity of the irradiation region, to be taken into account. In particular, this ensures that the direction of displacement of the assigned energy beam within the irradiation region is suitably aligned relative to the energy beam center of the energy beam, and/or that the parameter value of the irradiation parameter is suitably selected to at least mitigate any adverse effects, for example, of a flat angle of incidence.

In particular, the irradiation plan is obtained as a data set for controlling a manufacturing device, in particular a manufacturing device according to the present disclosure described below or a manufacturing device according to one or more of the embodiments described below, for additive manufacturing of a component from the powder material. Regardless of whether the method is carried out on a planning device arranged separately from a manufacturing device or on the manufacturing device itself, the irradiation plan is obtained in this way in an easily manageable, in particular machine-readable form. In particular, it is also preferable to be able to export the irradiation plan obtained as a data set and to transport it independently of a specific device, for example embodied on a data carrier or virtually via a network, in particular to transmit it.

An embodiment of the present disclosure provides a method for the additive manufacturing of at least one component from a powder material, hereinafter also referred to as a manufacturing method, which comprises the following steps: providing an irradiation plan obtained using a planning method according to the invention or a planning method according to one or more of the embodiments described above for the locally selective irradiation of a working area with at least one energy beam, in order to produce the at least one component layer by layer from a plurality of powder material layers of the powder material arranged in a layer sequence in temporal succession in the working region by means of the at least one energy beam, and manufacturing the at least one component according to the irradiation plan, in particular by means of the manufacturing device according to the present disclosure described below or a manufacturing device according to one or more of the embodiments described below. In connection with the manufacturing method, the advantages already explained above in connection with the planning method are particularly apparent.

In an embodiment, it is provided that the irradiation plan is provided by carrying out a planning method according to the present disclosure or a planning method according to one or more of the embodiments described above. Thus, the method for manufacturing the component also comprises the planning method, in particular in the form of upstream steps.

A laser beam or an electron beam is preferably used as the energy beam.

The component is preferably manufactured by means of selective laser sintering and/or selective laser melting.

A metallic or ceramic powder can be used as the powder material in a preferred manner.

The present disclosure also includes a computer program product comprising machine-readable instructions on the basis of which a planning method according to the present disclosure or a planning method according to one or more of the embodiments described above is carried out on a computing device when the computer program product is running on the computing device.

Alternatively or additionally, the computer program product comprises machine-readable instructions on the basis of which a manufacturing method according to the present disclosure or a manufacturing method according to one or more of the embodiments described above is carried out on the computing device when the computer program product is running on the computing device.

In connection with the computer program product, the advantages already explained in connection with the planning method or the manufacturing method arise in particular.

The present disclosure also includes a data carrier comprising a computer program product according to the present disclosure or a computer program product according to one or more of the embodiments described above.

An embodiment of the present disclosure provides a planning device for planning a locally selective irradiation of a working region with at least one energy beam in order to produce at least one component from a powder material arranged in the working region by means of the at least one energy beam, wherein the planning device is provided to perform a planning method according to the present disclosure or a planning method according to one or more of the embodiments described above. In connection with the planning device, the advantages already explained above in connection with the planning method, the manufacturing method, or the computer program product arise in particular.

In particular, the planning device may be set up to plan the locally selective irradiation of the working region with a plurality of energy beams.

In an embodiment, the planning device is designed as a device selected from a group consisting of a computer, in particular a personal computer (PC), a plug-in card or control card, and an FPGA board. In an embodiment, the planning device is an RTC5 or RTC6 control card from SCANLAB GmbH, in particular in the embodiment currently available on the date determining the priority of the present disclosure.

In particular, the planning device may be provided externally or separately from a manufacturing device, wherein the planning device preferably creates a data set which is then transmitted in a suitable manner, for example by means of a data carrier or via a network, in particular via the Internet, or via another suitable wireless or wired transmission form, to a manufacturing device, in particular a control device of a manufacturing device. For example, it is possible for the planning device to generate CAM data, i.e., in particular a command sequence, in particular an NC program, for controlling the manufacturing device from CAD data, wherein this command sequence is then transmitted to the manufacturing device for its control. It is also possible for CAD data of a component to be transferred to the planning device, wherein the planning device generates the command sequence for the manufacturing device from this data. However, the planning device can also be integrated into a manufacturing device. In particular, the planning device can be integrated into the control device of the manufacturing device, or the control device of the manufacturing device can be designed as a planning device, in particular by providing a suitable hardware component and/or by implementing a suitable computer program product, in particular software. For example, it is possible that CAD data of a component to be manufactured is then transferred to the manufacturing device, wherein the manufacturing device itself, in particular the planning device implemented in the control device, generates corresponding CAM data or a command sequence for controlling the manufacturing device from the CAD data. However, it is also possible that the planning device comprises a plurality of computing devices, wherein it is in particular physically distributed. Preferably, the planning device then comprises a plurality of interconnected computing devices. In particular, the planning device can be designed as a data cloud, or the planning device is part of a data cloud. In an exemplary embodiment, it is also possible for the planning device to comprise, on the one hand, at least one computing device external to the manufacturing device and, on the other hand, the manufacturing device, in particular the control device of the manufacturing device, wherein steps performed by the planning device are then performed partly on the external computing device and partly on the manufacturing device, in particular on the control device. In particular, it is also possible that the planning device does not take over the complete planning of the locally selective irradiation of the working region, but only parts thereof; in particular, it is possible that the planning device only takes over that part of the planning of the locally selective irradiation of the working region which relates to the steps and/or specifications described above. Other parts of the planning of the locally selective irradiation, on the other hand, can be carried out in other computing devices, in particular in computing devices external to the manufacturing device, or also in the manufacturing device itself, in particular its control device, or also in a data cloud. In particular, it is possible for the planning device to modify, adapt, or correct CAM data or a command sequence, in particular an NC program, generated by another computing device.

An embodiment of the present disclosure provides a manufacturing device for the additive manufacturing of components from a powder material. The manufacturing device has at least one beam generation device that is set up to generate at least one energy beam. In addition, the manufacturing device has at least one scanner device that is set up to irradiate a working area locally and selectively with the at least one energy beam in order to produce a component from the powder material arranged in the working area by means of the at least one energy beam. Finally, the manufacturing device has a control device that is operatively connected to the at least one scanner device and is set up to control the scanner device. The control device is designed to carry out a manufacturing method according to the present disclosure or a manufacturing method according to one or more of the embodiments described above. In connection with the manufacturing device, the advantages already explained in connection with the planning method, the manufacturing method, the computer program product, and the planning device are particularly apparent.

In an embodiment, the beam generation device is configured to generate a plurality of energy beams, and/or the manufacturing device has a plurality of beam generation devices for generating a plurality of energy beams. It is possible that a plurality of scanner devices are provided for the plurality of energy beams. However, it is also possible that the scanner device is set up to shift a plurality of energy beams—in particular independently of one another—on the working region. In particular, the scanner device may have a plurality of separately controllable scanners, in particular scanner mirrors, for this purpose.

The scanner device preferably has at least one scanner, in particular a galvanometer scanner, piezo scanner, polygon scanner, MEMS scanner, and/or a working head or processing head that can be moved relative to the working region. The scanner devices proposed here are particularly suitable for shifting the energy beam within the working region between a plurality of irradiation positions.

A working head or machining head that can be moved relative to the working region is understood here to be, in particular, an integrated structural element of the manufacturing device that has at least one radiation outlet for at least one energy beam, wherein the integrated structural element, i.e. the working head, can be moved as a whole along at least one displacement direction, preferably along two displacement directions perpendicular to each other, relative to the working region. Such a working head can in particular be designed in a gantry construction or be guided by a robot. In particular, the working head can be designed as the robot hand of a robot.

The control device is preferably selected from a group consisting of a computer, in particular a personal computer (PC), a plug-in card or control card, and an FPGA board. In a preferred embodiment, the control device is an RTC5 or RTC6 control card from SCANLAB GmbH, in particular in the embodiment currently available on the date determining the priority of the present disclosure.

Preferably, the at least one beam generation device has at least one laser. The at least one energy beam is thus advantageously generated as an intense beam of coherent electromagnetic radiation, in particular coherent light. Irradiation in this respect preferably means exposure to light.

The manufacturing device is preferably designed for selective laser sintering. Alternatively or additionally, the manufacturing device is designed for selective laser melting. These embodiments of the manufacturing device have proven to be particularly advantageous.

According to an embodiment of the present disclosure, the manufacturing device is provided with a protective gas device—as a source of the protective gas flow—which is designed to generate a protective gas flow with a defined flow direction over the working region.

In an embodiment, the manufacturing device additionally has a protective gas influencing device which is designed to determine, in particular to change, a flow parameter value of at least one flow parameter of the protective gas flow, wherein the at least one flow parameter is selected from a group consisting of: the flow direction above the working area and the flow velocity of the protective gas flow.

In particular, the control device is operatively connected to the protective gas influencing device and is arranged to select the at least one flow parameter value depending on the assignment of a respective irradiation region to a subregion of at least two subregions of the working region. In particular, the control device is designed to use the flow parameter as the at least one irradiation parameter.

The present disclosure is explained in more detail below with reference to the drawings.

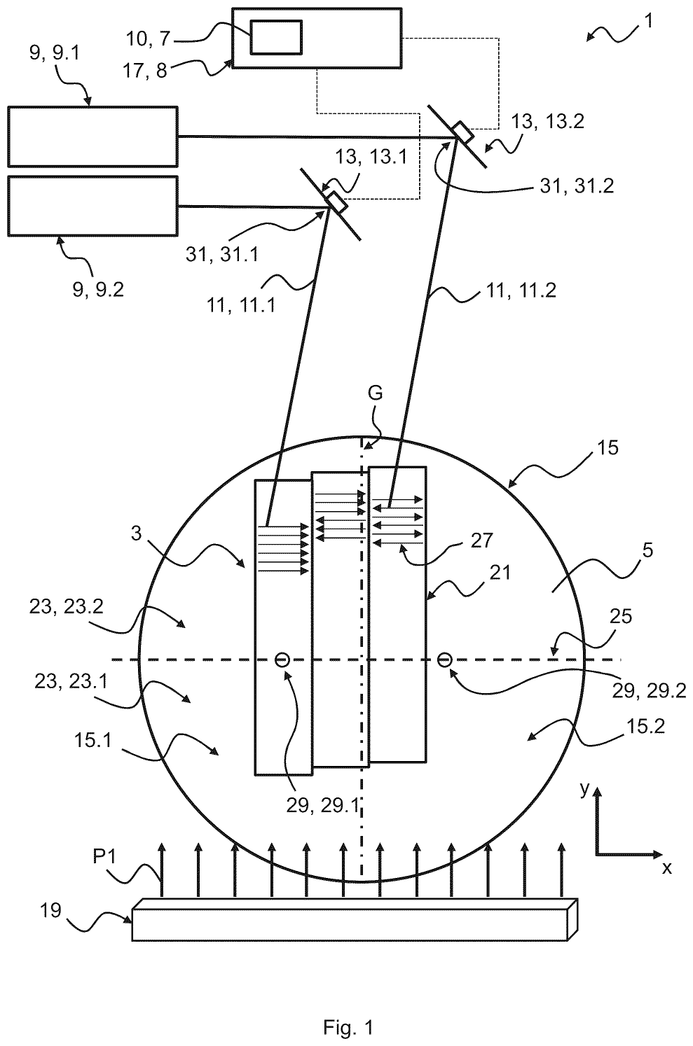

FIG. 1 shows a schematic representation of an embodiment of a manufacturing device 1 for additive manufacturing of a component 3 from a powder material 5 with an embodiment of a planning device 7.

The manufacturing device 1 has at least one beam generation device 9, preferably designed as a laser, which is set up to generate at least one energy beam 11, in particular a laser beam, and also a scanner device 13, which is designed to irradiate a working region 15 locally and selectively with the at least one energy beam 11 in order to produce the component 3 from the powder material 5 arranged in the working region 15 by means of the at least one energy beam 11. In particular, the beam generation device 9 generates more than one energy beam 11, or the manufacturing device 1 has more than one beam generation device 9 for generating a plurality of energy beams 11; FIG. 1 specifically shows a first beam generation device 9.1 for generating a first energy beam 11.1 and a second beam generation device 9.2 for generating a second energy beam 11.2. Preferably, the manufacturing device 1 has a separate scanner device 13 for each energy beam 11, namely a first scanner device 13.1 for the first energy beam 11.1 and a second scanner device 13.2 for the second energy beam 11.2. The manufacturing device 1 further comprises a control device 17, which is designed in particular as a computing device 8, which is operatively connected to the scanner device 13 and preferably also to the beam generation device 9 and is set up to control the scanner device 13 and, if necessary, the beam generation device 9. The control device 17 is designed to carry out a method described in more detail below for planning the locally selective irradiation of the working region 15 with the energy beam 11, also referred to as the planning method for short.

In particular, the control device 17 has a planning device 7, which is designed in particular as a further computing device 10 and is set up accordingly to carry out the planning method. Alternatively, it is possible that the control device 17 itself is designed as the planning device 7. However, in an embodiment not shown here, it is also possible for the planning method to be carried out on a planning device 7 provided separately from the manufacturing device 1.

The manufacturing device 1 also has a protective gas device 19, which is designed to generate a protective gas flow with a defined flow direction, as shown by the first arrows P1, above the working region 15.

The manufacturing device 1 is designed in particular to build up the component 3 layer by layer from a plurality of powder material layers arranged in a layer sequence in temporal succession in the working region 15. For this purpose, the working region 15, in particular in the form of a powder bed, is arranged on a building platform which is lowered step by step in a downward direction during the provision of the successive powder material layers in the working region 15. The powder material 5 forming the next powder material layer is conveyed from the area of a storage cylinder into the working region 15 by means of a coating element, in particular in the form of a wiper or pusher, and is smoothed there by the coating element so that the current powder material layer is provided. By successively consolidating the powder material 5 powder material layer by layer in this manner locally and selectively in the working region 15 by means of the energy beam 11, the component 3 is built up layer by layer, i.e., in layers.

It is possible that the first energy beam 11.1 can only be displaced within a first partial displacement region 15.1 and not in a second partial displacement region 15.2 of the working region 15, while the second energy beam 11.2 can conversely only be displaced within the second partial displacement region 15.2 and not in the first partial displacement region 15.1. The partial displacement regions 15.1, 15.2 are separated from each other in FIG. 1 by a dotted, imaginary boundary line G. In another embodiment, however, it is also possible that both energy beams 11.1, 11.2 can be shifted over the entire working region 15, or that they are assigned overlapping partial displacement regions 15.1, 15.2.

As part of a method, also referred to as a manufacturing method, for manufacturing the component 3 from the powder material 5, an irradiation plan obtained in particular with the aid of the planning method described below is provided for the locally selective irradiation of the working region 15 with the energy beam 11, and the component 3 is manufactured in accordance with the provided irradiation plan. The irradiation plan is preferably provided by carrying out the planning method, in particular by means of the planning device 7.

As part of the planning method, irradiation of a plurality of irradiation regions 21 on the working region 15 with the at least one energy beam 11 is planned, wherein a respective assigned parameter value of at least one irradiation parameter is selected for the irradiation regions 21, wherein the assigned parameter value is selected depending on an assignment of the respective irradiation region 21 to a subregion 23 of at least two subregions 23 of the working region 15. In this way, in particular, the irradiation plan for the locally selective irradiation of the working region 15 with the at least one energy beam 11 in the at least one powder material layer is obtained.

Specifically, in the embodiment of FIG. 1, the working region 15 is divided into two subregions 23, a first subregion 23.1 and a second subregion 23.2, by an imaginary separation line 25 shown there in dashed lines.

FIG. 1 also shows, by way of example, three lamellar irradiation regions 21, of which only one is marked with a reference symbol for the sake of clarity. In an embodiment, the irradiation regions 21 are irradiated in particular in the form of adjacent irradiation vectors 27 that are parallel offset to each other, wherein the irradiation vectors 27 are in particular aligned perpendicular to a longitudinal direction of the irradiation regions 21 and are arranged next to each other in the longitudinal direction. As schematically indicated, the irradiation vectors 27 within an irradiation region 21 can be oriented in concordant fashion relative to each other, oriented in inverse directions in groups, or alternately oriented in inverse directions. Other embodiments are also possible. In particular, the irradiation regions 21 are each completely covered or filled with irradiation vectors 27, or they are formed by the irradiation vectors 27, wherein for the sake of clarity only a few irradiation vectors 27 per irradiation region 21 are actually shown here.

The at least one irradiation parameter is selected in particular from a group consisting of: an irradiation order of at least two irradiation vectors 27 within the respective irradiation regions 21, a position of the irradiation regions 21 in a processing order of the plurality of irradiation regions 21, a vector direction of the irradiation vectors 27, a vector orientation of the irradiation vectors 27, a sequence of vector orientations of the irradiation vectors 27, a distance between mutually adjacent irradiation vectors 27 of the respective irradiation region 21, a beam power of the at least one energy beam 11, a shape of the energy beam 11 on the working region 15, a size of the energy beam 11 on the working region 15, a displacement velocity of the at least one energy beam 11 on the working region 15, a flow velocity of the protective gas flow over the working region 15, the flow direction P1 of the protective gas flow, a position of the irradiation regions 21 on the working region 15, and a combination of at least two of the aforementioned irradiation parameters.

FIG. 1 also shows two energy beam centers 29 on the working region 15, a first energy beam center 29.1 associated with the first energy beam 11.1, and a second energy beam center 29.2 associated with the second energy beam 11.2. An energy beam center 29 is understood to be a location on the working region 15 that results as the base point of the respective scanner device 13 for shifting the associated energy beam 11, in particular by dropping a perpendicular onto the working region 15 from respective starting point 31, 31.1, 31.2 of the assigned energy beam 11, 11.1, 11.2 on the respective scanner device 13, 13.1, 13.2.

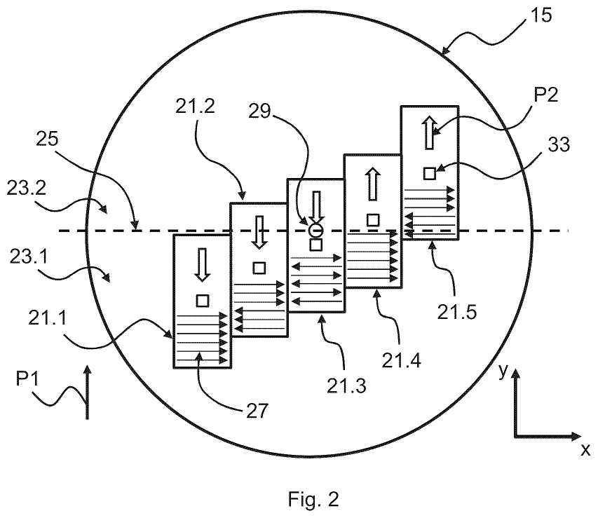

FIG. 2 shows a schematic representation of a first embodiment of the planning method.

Identical and functionally identical elements are designated by the same reference numerals in all figures, so that reference is made to the preceding description in each case.

In particular, in the embodiment described here, the irradiation order of the irradiation vectors 27 within the respective irradiation region 21, as represented by a second arrow P2, is used as the irradiation parameter, wherein five different irradiation regions 21 are shown here as examples: a first irradiation region 21.1, a second irradiation region 21.2, a third irradiation region 21.3, a fourth irradiation region 21.4, and a fifth irradiation region 21.5. For the sake of simplicity in the further explanations, only one energy beam center 29 of an energy beam 11 is shown in the embodiment described here. For the sake of clarity, only one of the second arrows P2 is marked with a reference symbol here.

In the embodiment shown, the working region 15 is again divided by exactly one separation line 25 into the first subregion 23.1 and the second subregion 23.2. The separation line 25 is, in particular, a diameter line of the circular working region 15. The separation line 25 is or becomes defined on the working region 15 in such a way that it runs through the energy beam center 29. Alternatively or additionally, the separation line 25 can run adjacent to the energy beam center 29 or through a center of gravity of a plurality of energy beam centers 29. The separation line 25 also runs perpendicular to the flow direction of the protective gas flow represented by the first arrow P1.

The irradiation order of the irradiation vectors 27 is now preferably selected for irradiation regions 21 assigned to the first subregion 23.1 in such a way that it is aligned against the protective gas flow, so that those irradiation vectors 27 which are closer to the separation line 25 and further away from the source of the protective gas flow, i.e. the protective gas device 19, are irradiated before irradiation vectors 27 that are further away from the separation line 25 and closer to the protective gas device 19. For irradiation regions 21 assigned to the second subregion 23.2, on the other hand, the irradiation order is selected so that it is aligned with the protective gas flow, so that irradiation vectors 27 that are closer to the separation line 25 and closer to the protective gas device 19 are irradiated before irradiation vectors 27 that are further away from the separation line 25 and further away from the protective gas device 19.

In order to assign the irradiation regions 21 to specific subregions 23, the following assignment criterion is used in particular: An irradiation region 21 is assigned to the subregion 23 in which a—in particular geometric—center of gravity 33 of the irradiation region 21 is located on the working region 15. The centers of gravity 33 of the irradiation regions 21 are each schematically indicated by a square in FIG. 2, wherein, for the sake of clarity, only one of the centers of gravity 33 is provided with a reference symbol. Alternatively or additionally, in an embodiment, it is provided as an assignment criterion that an irradiation region 21 is assigned to the subregion 23 in which it is located in its entirety. In particular, the respective irradiation region 21 can be divided along the separation line 25 if it falls into more than one subregion 23.

In particular, a first predetermined parameter value is assigned to the at least one irradiation parameter as the assigned parameter value if the respective irradiation region 21 is assigned to the first subregion 23.1, wherein a second parameter value, predetermined parameter value different from the first parameter value is assigned to the at least one irradiation parameter as the assigned parameter value if the respective irradiation region 21 is assigned to the second subregion 23.2.

In the embodiment shown, the irradiation order is selected along a first processing direction when the respective irradiation region 21 is assigned to the first subregion 23.1, wherein the irradiation order is selected along a second processing direction when the respective irradiation region 21 is assigned to the second subregion 23.2, wherein the first processing direction is aligned antiparallel to the flow direction of the protective gas flow, and wherein the second processing direction is aligned parallel to the flow direction.

In particular, due to the position of their centers of gravity 33 in the first subregion 23.1, the first irradiation region 21.1, the second irradiation region 21.2, and the third irradiation region 21.3 are assigned to the first subregion 23.1, and the irradiation order for the irradiation vectors 27 is selected for these three irradiation regions 21.1, 21.2, 21.3 along the first processing direction, i.e., against the flow direction. The fourth irradiation region 21.4 and the fifth irradiation region 21.5, on the other hand, are assigned to the second subregion 23.2 due to the position of their centers of gravity 33 in the second subregion 23.2, and accordingly, for these two irradiation regions 21.4, 21.5, the irradiation order of the irradiation vectors 27 is selected along the second processing direction and thus parallel to the flow direction.

Preferably, when using more than one energy beam 11, an additional irradiation parameter is used in the form of an assignment of a specific energy beam 11 from the plurality of energy beams 11 to the respective irradiation area 21. Alternatively or additionally, the assigned parameter value of the at least one irradiation parameter is selected depending on an assignment of a specific energy beam 11 of the plurality of energy beams 11 to the respective irradiation area 21.

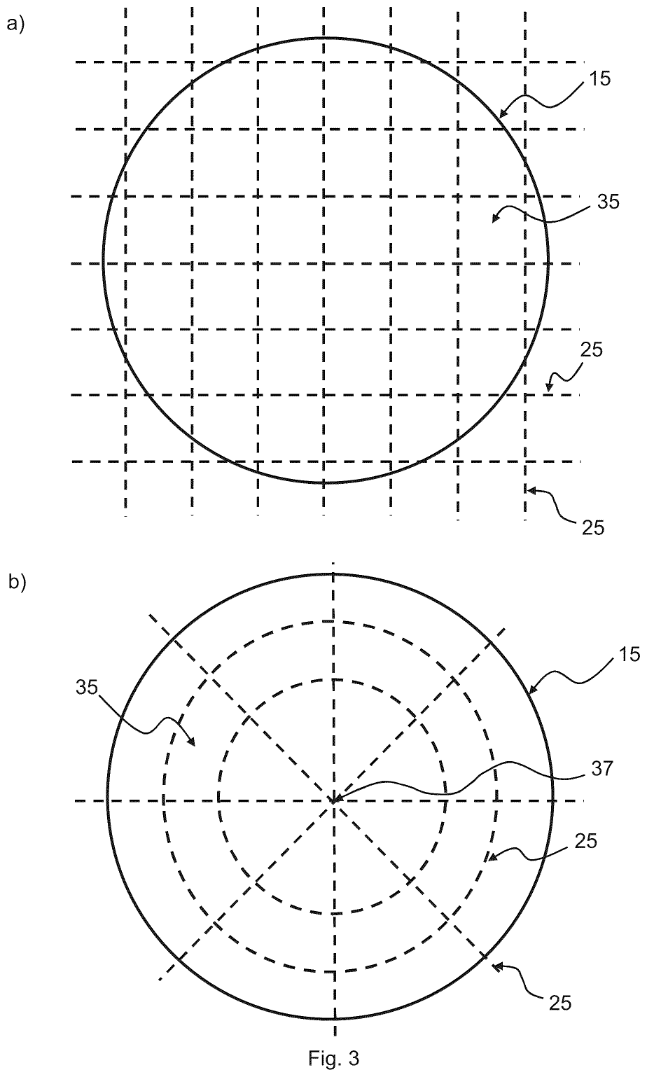

FIG. 3 shows schematic detailed representations of further embodiments of the method for planning a locally selective irradiation of the working region 15 with the at least one energy beam 11.
In a), it is schematically shown that rectangular, in particular square, fields 35 on the working region 15 are used as the at least two subregions 23. Accordingly, two diameter lines orthogonal to each other and secants parallel offset to the diameter lines are used as separation lines 25.
In b), it is schematically shown that fields 35 are used as the at least two subregions 23, which result as intersections of sectors and annuli of the working region 15. Accordingly, diameter lines and circular lines centered at a center point 37 of the working region 15 are used as separation lines 25.

Alternatively or additionally, fields 35 selected from a group consisting of sectors, sector segments, circle segments, annuli, free-form fields, and a combination of at least two of the aforementioned fields can be used as subregions 23.

Alternatively or additionally, 25 lines selected from a group consisting of radius lines, circle chords, parallel lines to a boundary edge of the working region 15, and a combination of at least two of the aforementioned lines can be used as separation lines.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for planning a locally selective irradiation of a working region with at least one energy beam, in order to produce at least one component layer by layer from a plurality of powder material layers of a powder material arranged in a layer sequence in temporal succession in the working region via the at least one energy beam, the method comprising:
planning irradiation of a plurality of irradiation regions on the working region with the at least one energy beam;
selecting a respective assigned parameter value of at least one irradiation parameter for the irradiation regions of the plurality of irradiation regions;
selecting the assigned parameter value depending on an assignment of the respective irradiation region to a subregion of at least two subregions of the working region; and
obtaining an irradiation plan for the locally selective irradiation of the working region with the at least one energy beam in at least one powder material layer.

2. The method according to claim 1, wherein the at least one irradiation parameter is selected from a group of: an irradiation order of at least two irradiation vectors within the respective irradiation region, a position of the respective irradiation region in a processing order of the plurality of irradiation regions, a vector direction of the at least two irradiation vectors, a vector orientation of the at least two irradiation vectors, a sequence of vector orientations of the at least two irradiation vectors, a distance between mutually adjacent irradiation vectors of the irradiation regions, a beam power of the at least one energy beam, a shape of the at least one energy beam on the working region, a size of the at least one energy beam on the working region, a displacement velocity of the at least one energy beam on the working region, a flow velocity of a protective gas flow over the working region, a flow direction of the protective gas flow, a position of the respective irradiation region on the working region, and combinations thereof.

3. The method according to claim 1, wherein the at least two subregions are fields on the working region selected from a group of: sectors, sector segments, circle segments, annuli, rectangular fields, free-form fields, and combinations thereof.

4. The method according to claim 1, wherein at least one separation line separating the at least two subregions on the working region from each other is defined on the working region in such a way that it runs
adjacent to at least one energy beam center, or
through the at least one energy beam center, or
through a center of gravity of a plurality of energy beam centers.

5. The method according to claim 1, wherein at least one separation line which separates the at least two subregions on the working region from one another is defined on the working region in such a way that it runs transversely to a flow direction of a protective gas flow over the working region.

6. The method according to claim 1, wherein the at least two subregions are defined on the working region prior to planning the irradiation of the plurality of irradiation regions by defining at least one separation line on the working region which separates at least two subregions of the at least two subregions from each other.

7. The method according to claim 4, wherein the at least one separation line is a line selected from a group of: a radius line, a diameter line, a circular line centered at a center point or center of gravity of the working area, a secant, a chord, a parallel line to a boundary edge of the working area, and combinations thereof.

8. The method according to claim 1, wherein the respective irradiation region is assigned to a specific subregion of the at least two subregions based on:
a position of a center of gravity of the respective irradiation region on the working region falling within the specific subregion, or
the respective irradiation region is located in the specific subregion, wherein the respective irradiation region is divided if it falls within more than one subregion of the at least two subregions.

9. The method according to claim 1, wherein a first predetermined parameter value is assigned to the at least one irradiation parameter as an associated parameter value if the respective irradiation region is assigned to a first subregion of the at least two subregions of the working region, wherein a second predetermined parameter value different from the first parameter value is assigned to the at least one irradiation parameter as the associated parameter value if the respective irradiation region is assigned to a second subregion of the at least two subregions.

10. The method according to claim 1, wherein an irradiation order of at least two irradiation vectors within the respective irradiation region is used as the at least one irradiation parameter, wherein
the irradiation order is selected along a first processing direction if the respective irradiation region is assigned to a first subregion of the at least two subregions of the working region, wherein
the irradiation order is selected along a second processing direction if the respective irradiation region is assigned to a second subregion of the at least two subregions, wherein
the first processing direction has at least one component that is aligned antiparallel to a flow direction of a protective gas flow over the working area, and wherein
the second processing direction has at least one component that is aligned parallel to the flow direction, wherein the second processing direction is aligned antiparallel to that of the first processing direction.

11. The method according to claim 2, wherein the irradiation is planned with a plurality of energy beams, wherein an assignment of a specific energy beam of the plurality of energy beams to the respective irradiation region is used as an additional irradiation parameter.

12. The method according to claim 1, wherein the irradiation with a plurality of energy beams is planned, wherein the assigned parameter value of the at least one irradiation parameter is additionally selected as a function of an assignment of a specific energy beam of the plurality of energy beams to the respective irradiation region.

13. A method for additive manufacturing of at least one component from a powder material, comprising:
providing an irradiation plan via a method according to claim 1 for the locally selective irradiation of a working region with at least one energy beam, in order to produce the at least one component layer by layer from a plurality of powder material layers of the powder material arranged in a layer sequence in temporal succession in the working region via the at least one energy beam, and
producing the at least one component in accordance with the irradiation plan.

14. A planning device for planning a locally selective irradiation of a working region with at least one energy beam, in order to produce at least one component from a powder material arranged in the working region via the at least one energy beam, wherein the planning device is designed to carry out a method according to claim 1.

15. A manufacturing device for additive manufacturing of components from a powder material, comprising:
at least one beam generation device which is designed to generate at least one energy beam,
at least one scanner device which is designed to irradiate a working region locally and selectively with the at least one energy beam in order to produce at least one component from the powder material arranged in the working region via the at least one energy beam, and
a control device that is operatively connected to the at least one scanner device and is designed to control the at least one scanner device.

16. The manufacturing device according to claim 15, further comprising a protective gas device which is designed to generate a protective gas flow with a defined flow direction over the working area.
